(19) United States
(12) Patent Application Publication
(10) Pub. No.: US 2015/0013400 A1
(43) Pub. Date: Jan. 15, 2015

(54) Blocking Device for a Refrigerator

(71) Applicant: Edilberto ACÁCIO DA SILVA, Ribeirao Preto (BR)

(72) Inventor: Edilberto ACÁCIO DA SILVA, Ribeirao Preto (BR)

(21) Appl. No.: 14/324,686

(22) Filed: Jul. 7, 2014

(30) Foreign Application Priority Data
Jul. 9, 2013 (BR) MU-9102215-0

(51) Int. Cl. E05B 65/00; G07C 9/00

(52) U.S. Cl. CPC E05B 65/0042; G07C 9/00158
USPC 70/101

(57) ABSTRACT

A structural arrangement for a lock for a refrigerator is provided and consists of a blocking device to prevent the refrigerator from being opened by unauthorized persons. A refrigerator comprises a generally parallelepipedal body provided with at least one door; the blocking device is comprised of two components, the front component that is disposed on the door and the side component that is disposed on the side. The blocking device includes a pin in the front component that is adapted to actuate to be inserted into the side component to lock the refrigerator. The blocking device also contains an actuating system that prevents unauthorized persons from opening the refrigerator.

### FIELD OF THE INVENTION

The present invention is directed towards a lock generally for refrigerators, the lock being a blocking device generally to prevent the refrigerator from being opened by unauthorized persons.

### DISCLOSURE OF THE INVENTION

Presently, refrigerators are used in a number of locations and for varying purposes. For example, refrigerators are used in hotels, restaurants, laboratories and personal homes. Refrigerators may store food stuff and medicines that should not be accessed or consumed by all individuals. Presently refrigerators are not provided with a system to prevent the refrigerator from being opened by any person.

Therefore, there is a need for a refrigerator provided with a locking device object of the present invention. In particular, the present invention discloses a refrigerator provided with a blocking device on the door thereof to prevent unauthorized persons from opening the refrigerator and accessing or using the products contained therein.

### BRIEF DESCRIPTION OF THE DRAWINGS

FIG. 1—a front view of the new structural arrangement in a refrigerator provided with a blocking device having a coding system;

FIG. 2—a partial perspective view of the refrigerator provided with a blocking device having a coding system;

FIG. 3—a perspective view of the refrigerator provided with a blocking device having a coding system in the open position;

FIG. 4—a front view of a first embodiment of the refrigerator provided with a blocking device having a card system;

FIG. 5—a partial perspective view of the refrigerator provided with a blocking device having a card system;

FIG. 6—a perspective view of the refrigerator provided with a blocking device having a card system in the open position;

FIG. 7—a front view of a second embodiment of the refrigerator provided with a blocking device having a voice operated system;

FIG. 8—a partial perspective view of the refrigerator provided with a blocking device having a voice operated system;

FIG. 9—a perspective view of the refrigerator provided with a blocking device having a voice operated system in the open position;

FIG. 10—a front view of a third embodiment of the refrigerator provided with a blocking device having a digital finger print scanning system;

FIG. 11—a partial perspective view of the refrigerator provided with a blocking device having a digital finger print scanning system;

FIG. 12—a perspective view of the refrigerator provided with a blocking device having a digital finger print scanning system in the open position;

FIG. 13—a front view of a fourth embodiment of the refrigerator provided with a blocking device having a shuttering system;

FIG. 14—a partial perspective view of the refrigerator provided with a blocking device having a shuttering system;

FIG. 15—a perspective view of the refrigerator provided with a blocking device having a shuttering device in the open position;

FIG. 16—a front view of a fifth embodiment of the refrigerator provided with a blocking device having a switching system;

FIG. 17—a partial perspective view of the refrigerator provided with a blocking device having a switching system;

FIG. 18—a perspective view of the refrigerator provided with a blocking device having a switching system in the open position;

FIG. 19—a front view of a sixth embodiment of the refrigerator provided with a blocking device having a remote control system;

FIG. 20—a partial perspective view of the refrigerator provided with a blocking device having a remote control system;

FIG. 21—a perspective view of the refrigerator provided with a blocking device having a remote control system in the open position;

FIG. 22—a front view of a seventh variant of the refrigerator provided with a blocking device having a locking system;

FIG. 23—a partial perspective view of the refrigerator provided with a blocking device having a locking system;

FIG. 24—a front view of an eighth variant of the refrigerator provided with a blocking device having a hand recognizing digital system;

FIG. 25—a partial perspective view of the refrigerator provided with a blocking device having a hand recognizing digital system;

FIG. 26—a perspective view of the blocking device having a hand recognizing digital system on the blocking device in the open position.

### DETAILED DESCRIPTION OF THE INVENTION

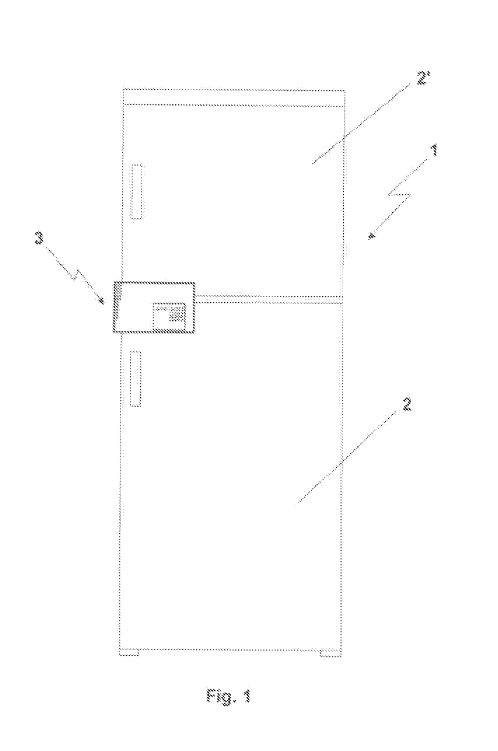

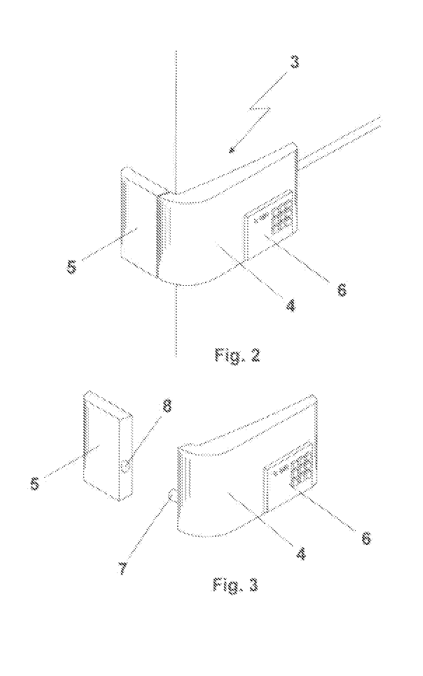

Turning to FIGS. 1 through 3 a first embodiment of the present invention is illustrated. A refrigerator (1) may be comprised of a generally parallelepipedal body provided with two doors (2; 2′) and an L-shaped blocking device (3). Blocking device (3) is adapted to lock refrigerator (1). The upper portion of blocking device (3) may abut the lower face of the door (2′). Lower portion of blocking device (3) may be placed on door (2) as is described in greater detail below. Thus blocking device (3) may be able to block both door (2) and door (2′).

Blocking device (3) may be composed of two separable bodies, front component (4) and side component (5). Front component (4) may be disposed on the front of door (2). Body (5) may be positioned on the side of said refrigerator (1). Body (4) may include a locking member (6) that may actuate a pin (7). Body (5) may include a hole (8) adapted to receive pin (7).

Refrigerator provided with blocking device (3) may be locked by the actuating system (6) pushing pin (7) into the hole (8). In order to unlock the door, actuating (6) may remove pin (7) from hole (8).

In the embodiment shown in FIGS. 1 through 3 the actuating system (6) is a coding system.

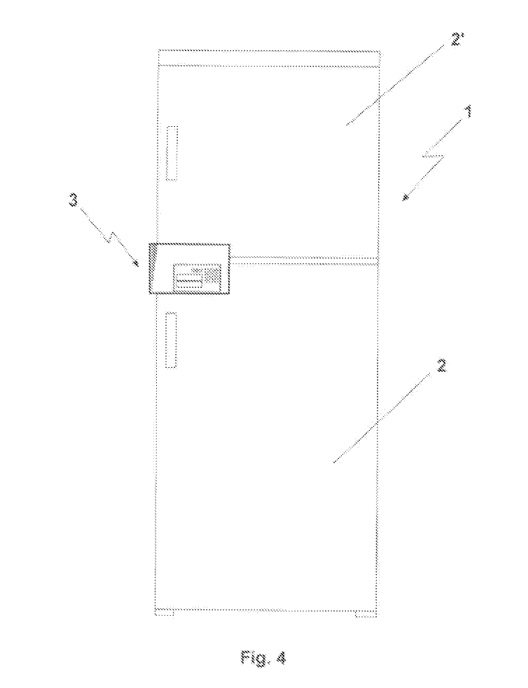

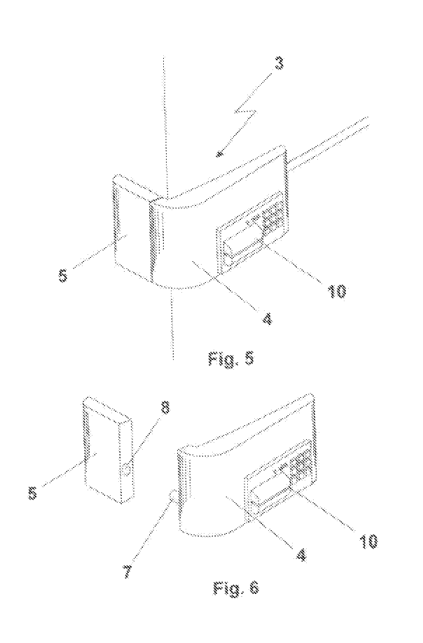

Optionally, in a second embodiment, illustrated in FIGS. 4 through 6, blocking device (3) is provided with an actuating system comprised of a card system (10).

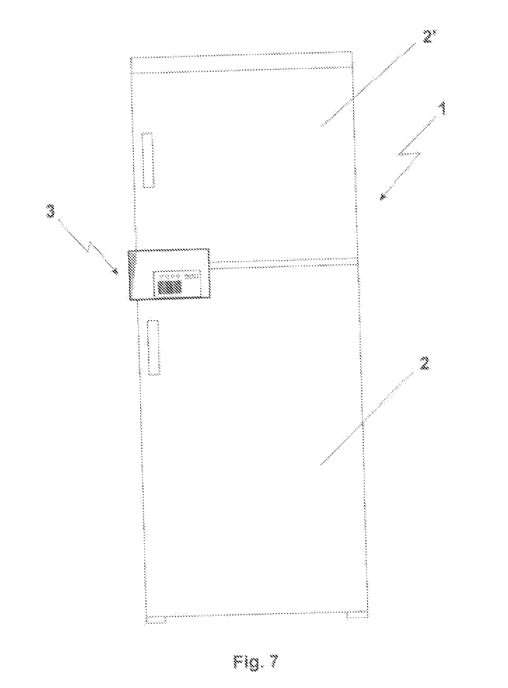

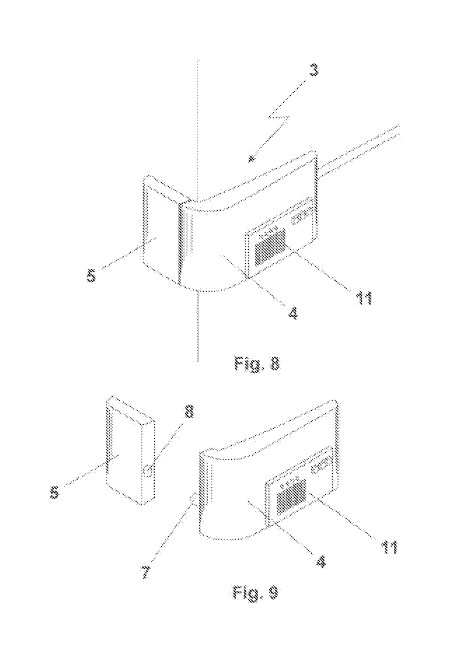

Optionally, in another embodiment, illustrated in FIGS. 7 through 9, blocking device (3) is provided with a voice operated system (11).

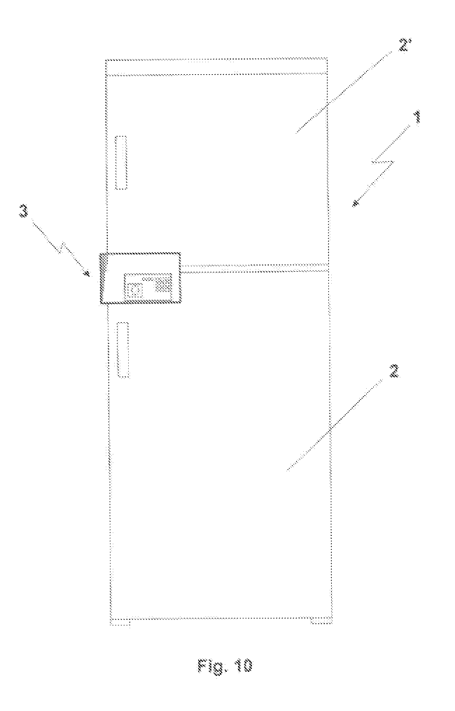

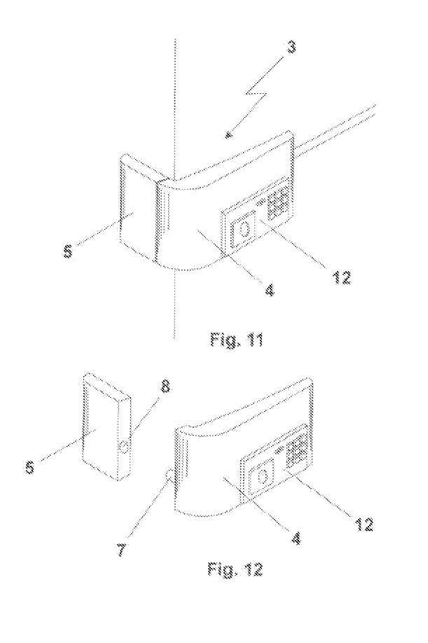

Optionally, in a third embodiment, illustrated in FIGS. 10 through 12, blocking device (3) is provided with an actuating system comprised of a digital printing system (12).

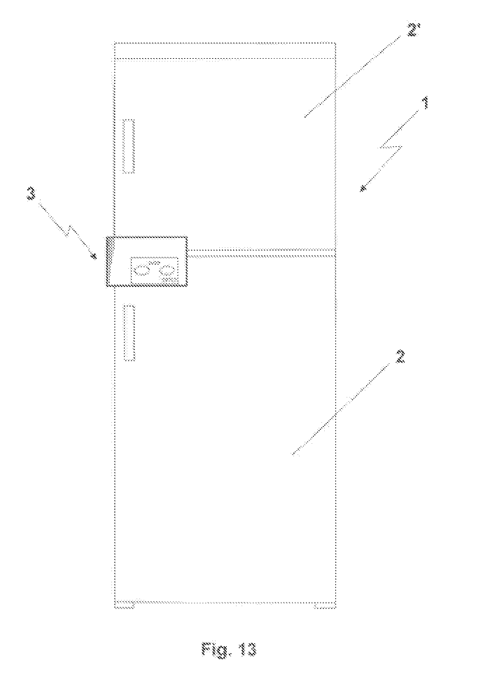

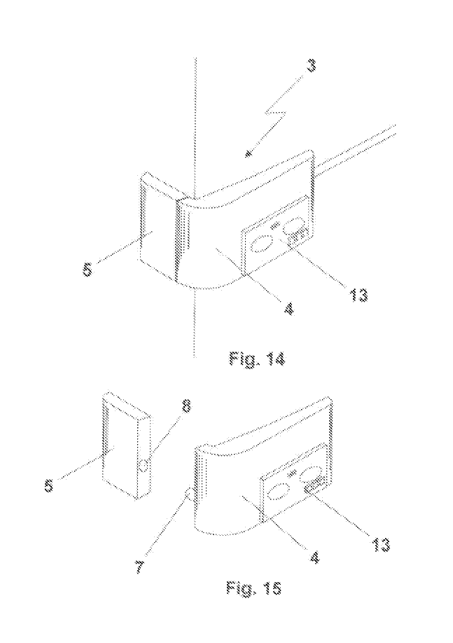

Optionally, in a fourth embodiment, illustrated in FIGS. 13 through 15, blocking device (3) is provided with an actuating system comprised of a shuttering system (13).

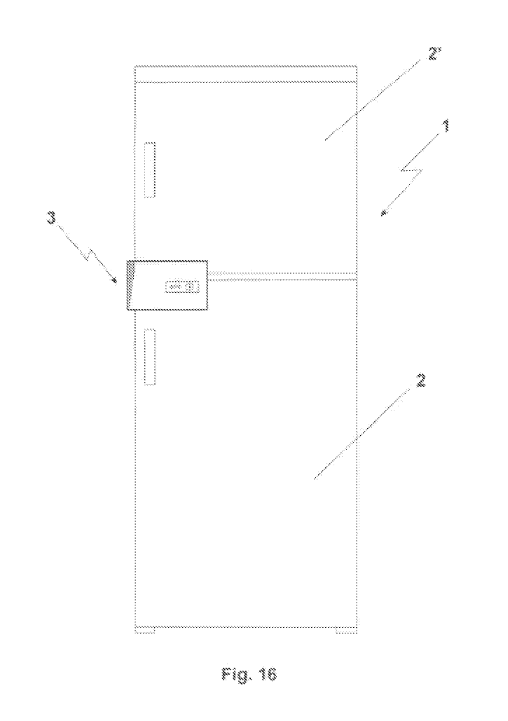

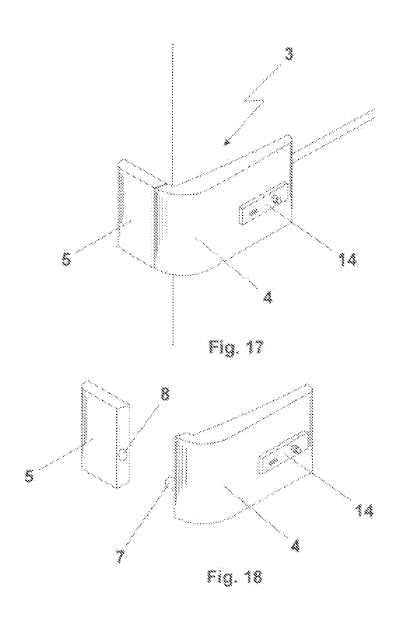

Optionally, in a sixth embodiment, illustrated in FIGS. 16 through 18 blocking device (3) is provided with an actuating system comprised of a switching system (14).

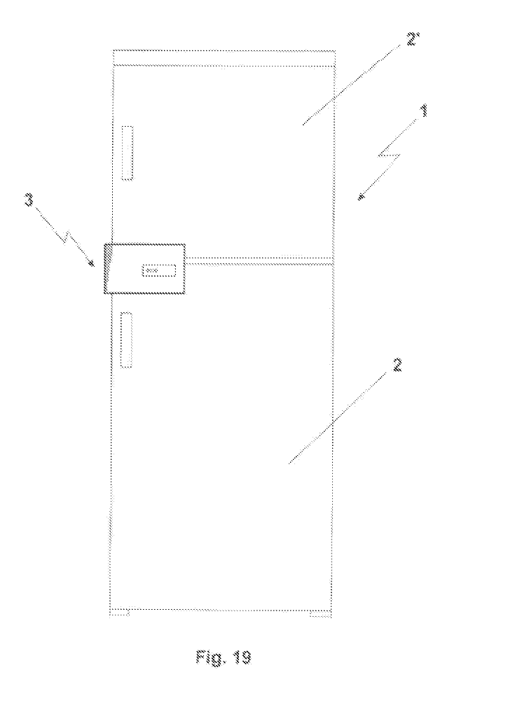

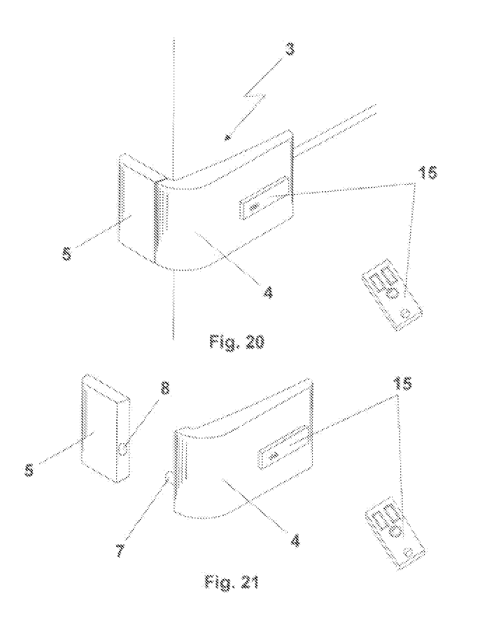

Optionally, in a seventh embodiment, illustrated in FIGS. 19 through 21, blocking device (3) is provided with an actuating system comprised of a remote system (15).

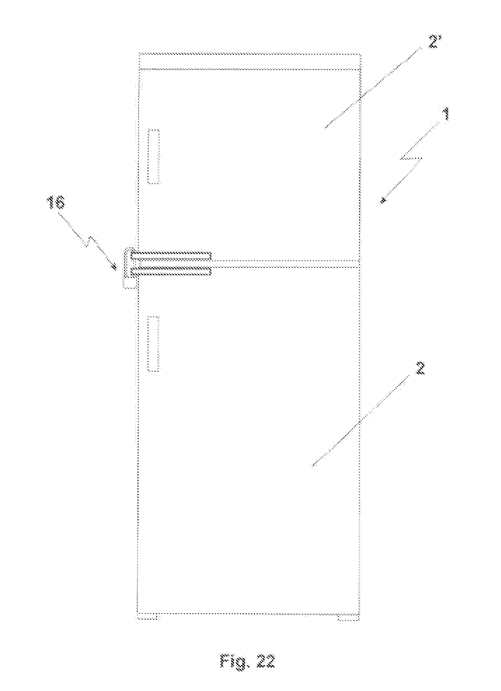

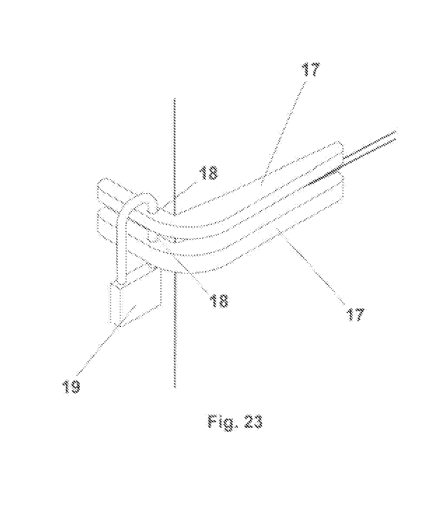

Optionally, in an eighth embodiment, illustrated in FIGS. 22 and 23, blocking device (3) is provided with a locking system (16) comprised of two L shaped parallel rods (17) located on the upper end of the door (2) and the lower end of the door (2′), respectively, so that the holes (18) thereon are aligned, thus allowing a lock (19) to be inserted therethrough.

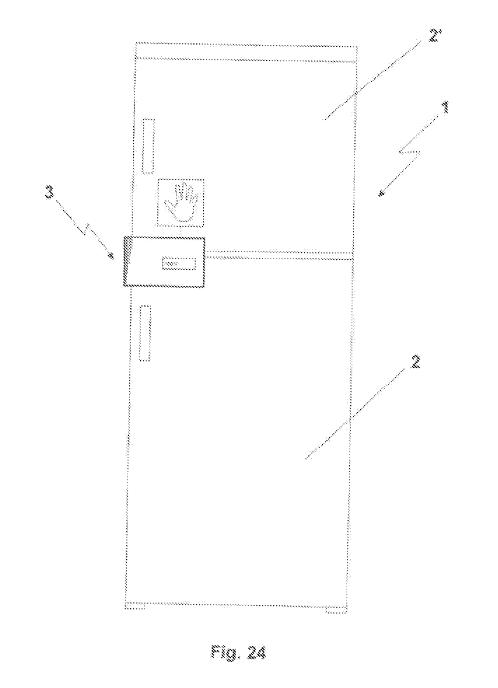

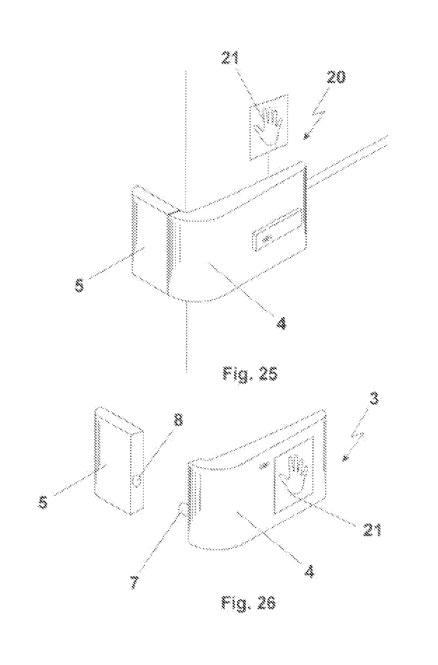

Optionally, in a ninth embodiment illustrated in FIGS. 24 and 25, blocking device (3) may be provided with an actuating device comprised of a hand recognizing digital system (20) through which a hand recognizing sensor (21) may attached to any portion of refrigerator (1) may be internally connected to blocking device (3).

Alternatively, as illustrated in FIG. 26, hand recognizing sensor (21) may also be positioned on the blocking device (3) itself.

The refrigerator provided with the blocking device thus provides the benefit of preventing access to the refrigerator by unauthorized persons. Thus blocking device assures increased safety and privacy by preventing undue use and privacy.

While different embodiments and examples the present invention has been described above and illustrated in the figures, the scope of the claims should not be limited to the preferred embodiments set forth in the examples, but should be given the broadest interpretation consistent with the description as a whole.

1. A blocking device for a refrigerator, said refrigerator being comprised of:
a generally parallelepipedal body; and
at least one door on the front of said body, said blocking device being comprised of:
a first body affixable to the side of said body;
a second body affixable to the side of said body having a hole;
a pin in said first body adapted to be actuated to enter said hole in said second body to prevent said at least one door from being opened; and
an actuating system for actuating said pin, wherein said actuating system can only be actuated by authorized persons.

2. The blocking device of claim 1, wherein said actuating system is a coding system.

3. The blocking device of claim 1, wherein said actuating system is a card system.

4. The blocking device of claim 1, wherein said actuating system is a voice operated system.

5. The blocking device of claim 1, wherein said actuating system is a digital finger print scanning system.

6. The blocking device of claim 1, wherein said actuating system is a shuttering system.

7. The blocking device of claim 1, wherein said actuating system is a switching system.

8. The blocking device of claim 1, wherein said actuating system is a remote control system.

9. The blocking device of claim 1, wherein said actuating system is comprised of a hand recognizing digital system having a hand recognizing sensor.

10. The blocking device of claim 9, wherein said hand recognizing sensor is located separate from said blocking device.

11. The blocking device of claim 9, wherein said hand recognizing sensor is located on said blocking device.

12. The blocking device of claim 1, wherein said refrigerator has two doors and said blocking device prevents said two doors from being opened.

13. A blocking device for a refrigerator said refrigerator being comprised of:
a generally parallelepipedal body;
a first lower door on the front of said body; and
a second upper door on the front of said body, said blocking device being comprised of:
two L shaped parallel rods located on the upper end of said lower door and the lower end of said upper door, each of said rods having holes that are aligned when said doors are closed;
wherein a lock may be inserted into said aligned holes to prevent said doors from being opened.
